(19) United States
(12) Patent Application Publication
(10) Pub. No.: US 2023/0319280 A1
(43) Pub. Date: Oct. 5, 2023

(54) AUTOMATIC GENERATION OF H.264 PARAMETER SETS TO RECOVER VIDEO FILE FRAGMENTS

(71) Applicant: Qatar Foundation for Education, Science and Community Development, Doha (QA)

(72) Inventors: Husrev Taha Sencar, Doha (QA); Enes Altinisik, Doha (QA)

(21) Appl. No.: 18/131,002

(22) Filed: Apr. 5, 2023

Related U.S. Application Data
(60) Provisional application No. 63/327,629, filed on Apr. 5, 2022.

(51) Int. Cl. H04N 19/13; H04N 19/91; H04N 19/172

(52) U.S. Cl. CPC H04N 19/13; H04N 19/91; H04N 19/172

(57) ABSTRACT

A method for generating a Sequence Parameter Set and a Picture Parameter Set for decoding an H.264 coded video file fragment is provided. The method includes identifying a start of frame data, creating a parameter dictionary, detecting an entropy coding-mode, updating the parameter dictionary, identifying a plurality of headers, and verifying a generated picture.

### CROSS-REFERENCES TO RELATED APPLICATIONS

The present disclosure claims priority to U.S. Provisional Patent Application 63/327,629 titled “AUTOMATIC GENERATION OF H.264 PARAMETER SETS TO RECOVER VIDEO FILE FRAGMENTS” having a filing date of Apr. 5, 2022, the entirety of which is incorporated herein.

### BACKGROUND

In the process of encoding, image or video files can be compressed for efficient storage and ease of transfer. Decoding is essentially the opposite of encoding. The process of decoding translates the previously encoded compressed image or video file back to the original file. As the complexity of encoding increases, a large number of encoding parameters are set and used for compressing images and videos, which then guide the decoding process. These encoding parameters, or parameters, are encapsulated within a file header. Current decoding technology relies on the parameters encapsulated in the file header to execute the decoding process. Without the file header, the parameters required for the decoding process are unavailable, and therefore, decoding cannot occur.

While the file header is necessary for the decoding process, a file header only comprises a very small part of the overall file data, and there are many situation in which the file header may be missing. For example, in digital forensics, digital evidence is extracted through a process known as file carving, which commonly encounters partially deleted files. In another example, in the network monitoring domain deep packet inspection, packet loss is inevitable in high-speed data links. Thus, current technology that relies on file headers may be unable to decode standalone fragments of the two most common types of file fragments, JPEG or H.264. Further, even if the file headers were present, the reliance on file headers slows down the recovery process.

Accordingly, improved systems, methods, and devices for decoding file fragments without file headers are needed.

### SUMMARY

The present disclosure generally relates to systems, methods, and devices for decoding file fragments without file headers.

In light of the present disclosure, and without limiting the scope of the disclosure in any way, in an aspect of the present disclosure, which may be combined with any other aspect listed herein unless specified otherwise, a method for decoding file fragments without file headers is provided.

In an aspect of the present disclosure, which may be combined with any other aspect listed herein unless specified otherwise, a method for generating a Sequence Parameter Set and a Picture Parameter Set for decoding an H.264 coded video file fragment includes, identifying a start of frame data, creating a parameter dictionary, detecting an entropy coding-mode, updating the parameter dictionary, identifying a plurality of headers, and verifying a generated picture.

In accordance with a second aspect of the present disclosure, which may be used in combination with any other aspect listed herein unless stated otherwise, the start of frame data is identified by identifying an Instantaneous Decoder Refresh.

In accordance with a third aspect of the present disclosure, which may be used in combination with any other aspect listed herein unless stated otherwise, the parameter dictionary comprises a plurality of tuples.

In accordance with a fourth aspect of the present disclosure, which may be used in combination with any other aspect listed herein unless stated otherwise, the plurality of tuples represents a plurality of parameters in the Sequence Parameter Set, and wherein the plurality of tuples represents a plurality of parameters in the Picture Parameter Set.

In accordance with a fifth aspect of the present disclosure, which may be used in combination with any other aspect listed herein unless stated otherwise, the plurality of parameters in the Sequence Parameter and the plurality of parameters in the Picture Parameter Set comprise core parameters.

In accordance with a sixth aspect of the present disclosure, which may be used in combination with any other aspect listed herein unless stated otherwise, the entropy coding-mode is detected with a classifier.

In accordance with a seventh aspect of the present disclosure, which may be used in combination with any other aspect listed herein unless stated otherwise, the classifier differentiates between a first entropy coding mode using a CABAC coding method and a second entropy coding mode using a CAVLC coding method.

In accordance with an eighth aspect of the present disclosure, which may be used in combination with any other aspect listed herein unless stated otherwise, wherein a correlation between the generated picture decoded with a generated header and an original picture decoded using an original header is used to verify the generated picture.

In accordance with a ninth aspect of the present disclosure, which may be used in combination with any other aspect listed herein unless stated otherwise, a method for generating a file header for decoding a file fragment includes constructing a dataset, extracting a plurality of core parameters in the dataset, and using the plurality of core parameters to create a parameter dictionary.

In accordance with a tenth aspect of the present disclosure, which may be used in combination with any other aspect listed herein unless stated otherwise, the file fragment is a video file fragment encoded using an H.264 format.

In accordance with an eleventh aspect of the present disclosure, which may be used in combination with any other aspect listed herein unless stated otherwise, the file header comprises a Sequence Parameter Set.

In accordance with a twelfth aspect of the present disclosure, which may be used in combination with any other aspect listed herein unless stated otherwise, the file header comprises a Picture Parameter Set.

In accordance with a thirteenth aspect of the present disclosure, which may be used in combination with any other aspect listed herein unless stated otherwise, the parameter dictionary comprises a plurality of tuples.

In accordance with a fourteenth aspect of the present disclosure, which may be used in combination with any other aspect listed herein unless stated otherwise, the plurality of tuples represents a plurality of parameters in the Sequence Parameter Set, and wherein the plurality of tuples represents a plurality of parameters in the Picture Parameter Set.

In accordance with a fifteenth aspect of the present disclosure, which may be used in combination with any other aspect listed herein unless stated otherwise, the plurality of parameters in the Sequence Parameter and the plurality of parameters in the Picture Parameter Set comprise core parameters.

In accordance with a sixteenth aspect of the present disclosure, which may be used in combination with any other aspect listed herein unless stated otherwise, a method for generating a plurality of parameters used for decoding a file fragment includes inputting a plurality of I frames and a parameter dictionary into a system, wherein the system executes the method comprising, detecting an entropy coding-mode, updating the parameter dictionary, identifying a plurality of headers, and verifying a generated picture.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

The accompanying figures depict various elements of the one or more embodiments of the present disclosure, and are not considered limiting of the scope of the present disclosure.

In the Figures, some elements may be shown not to scale with other elements so as to more clearly show the details. Additionally, like reference numbers are used, where possible, to indicate like elements throughout the several Figures.

FIG. 1 is dataset, according to various examples of the present disclosure.

FIG. 2 is a method for decoding file fragments, according to various examples of the present disclosure.

### DETAILED DESCRIPTION

Generally, decoding technology relies on file headers. However, these headers are not always available. Thus, current technology that relies on file headers may be unable to decode standalone fragments of JPEG or H.264 file fragments, which are the two most common files. Further, the reliance on file headers slows down the recovery process. Thus, aspects of the present disclosure may address the above-discussed disadvantages in current file recover technology.

Video files are created with two defined processes. First, the video encoding process reduces temporal and spatial correlations in the original sequence of frames by predicting frame regions using other visually similar regions. One example of a coding standard is H.261, which was introduced in 1988. Further, while there are several coding standards in use today, H.264 is the most common coding standard, which is used as the standard for a majority of videos.

Second, video files are defined by the encapsulation of the encoded data with other essential data, including coded audio data, encoding parameters, and subtitles in a file container, which have several types. For example, MP4 and MWV are two types of file containers available for streaming and storing videos. As previously introduced, the file containers act as a wrapper and encapsulate the encoded data. Thus, the process of recovering video data depends on the ability to identify and decode the coded video frames.

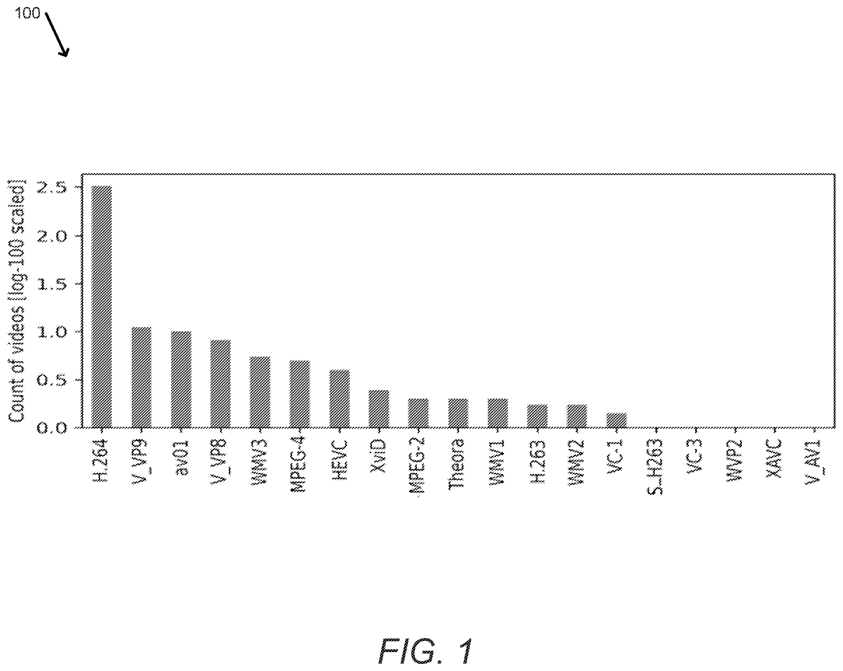

To examine video encoding characteristics, a dataset of videos was constructed. Namely, a decentralized content sharing website was crawled. The crawled website did not re-encode videos that where uploaded by users. Therefore, the dataset included a collection of videos with various cameras that were processed by various editing tools. This process resulted in the download of 102,846 videos, shared by 16,874 individuals. Two additional datasets were added to the original dataset, which resulted in the 104,139 total videos. Of the videos in the dataset, over 99% were encoded using H.264 format. The dataset and corresponding video file formats are depicted in the graph 100 of FIG. 1. Based on the prevalence of the H.264 format within the constructed dataset and current technology, an example embodiment of the present disclosure decodes file fragments that use the H.264 encoding process.

The H.264 standard organizes the functions of video coding into two conceptual layers: the Video Coding Layer (“VCL”) and (2) the Network Access Layer (“NAC”). The VCL governs the encoding process and includes all functions related to the compression of video frames. The NAL involves encapsulation of the encoded data for efficient storage and transfer. In an example, an H.264 bitstream contains a sequence of NAL units, which serve as the building blocks of the H.264 stream. Therefore, from a data recovery perspective, the data within the NAL units must be the identified, extracted, and interpreted even when some of the NAL are missing.

Each NAL unit includes a one-byte header where the trailing 5-bits after the one-byte header specify the type of unit followed by a sequence of bytes called the raw byte sequence payload (“RBSP”). The NAL units are byte aligned and are separated from each other by a prefix, referred to as start code. The payload of NAL units can either include encoded video data provided by the VCL or some additional information needed by the decoder. However, the latter type of payload includes the Sequence Parameter Set (“SPS”) and the Picture Parameter Set (“PPS”).

The SPS contains parameters that apply to a sequence of pictures, including one Instantaneous Decoder Refresh (“IDR”) picture and many non-IDR pictures. These parameter values declare the needed capabilities for decoding the video stream and initialize parameters that vary at the sequence level.

At a high level, SPS includes four groups of parameters. The first group specifies the required capabilities for the decoder. These essentially allow the decoder to decide whether it can support the video encoding settings such as resolution, bitrate, and frame rate. The second group of parameters defines the sequence properties, such as bit lengths of several variables and the number of frames that must be stored in the reference buffer. The decoder uses these parameters when parsing the bitstream and for memory management. Resolution-related parameters comprise another group. These parameters set the width and height values at a 16-pixel granularity in accordance with the size of a macroblock. If the width or height is not a multiple of 16, the remaining portions are defined in a number of frame-cropping parameters. The last group does not directly affect encoding. It involves parameters like the ID assigned to each SPS which can be changed freely as long as it is kept consistent within the sequence. Similarly, the optional video usability information (VUI) parameters are only involved in the post-decoding stage when generating the video, after individual pictures are reconstructed.

For every picture in a sequence, there may be a separate PPS specifying the encoding parameters of the picture. The most important of these is the entropy coding mode, designating which of the two methods, namely the Context-Adaptive Binary Arithmetic Coding (“CABAC”) or Context-Adaptive Variable-Length Coding (“CAVLC”), is used for losslessly compressing coded picture data. In addition, several parameters define the structure of the slice groups for a picture and the mode of motion prediction. Another subgroup of parameters set the default quantization values related to macroblock data in picture slices. Finally, one parameter determines if the deblocking filter is applied at its default setting or using a custom setting with involved parameters specified in another NAL unit.

The SPS NAL unit (“SPS Header”) contains parameters that are common among a series of consecutive coded video pictures. The PPS NAL unit (“PPS Header”) further complements the SPS by specifying parameters that apply to decoding of one or more pictures. Unlike the other NAL units that contain non-VCL payload, without these two units, video frames cannot be decoded. The SPS and PPS information is followed by the coded video pictures that can be contained within several types of NAL units. Among these, the IDR picture marks the earliest frame that can be referenced during decoding and corresponds to an updated SPS and PPS. The IDR and non-IDR pictures can be divided into multiple slices during coding and each slice is contained within a separate NAL unit. Overall, each IDR NAL unit and the following non-IDR unit can be decoded successfully when corresponding SPS and PPS unit are available.

Based on the previously introduced functions of SPS Headers and PPS Headers, the placement of such headers may be important to process of decoding video frames. In many examples, a single SPS and PPS are placed at the start of a video data stream. However, several use cases dictate their repetition. The byte stream format described in the standard inserts an SPS Header and a PPS Header before each IDR picture and a PPS Header before non-IDR pictures. In the case of video streaming, this placement may be preferable because it allows a decoder to start decoding midstream. In addition, the encoder may vary parameters in different parts of the stream to achieve a target bitrate or quality. Besides data for video streaming, many video files are intended for download and storage. Thus, one copy of each unique SPS and PPS unit may be stored in some part of the file, especially if they remain fixed for the whole video stream. Video file containers tend to use this approach because of its efficiency. However, if the SPS Headers and PPS Headers cannot be located, decoding cannot be performed.

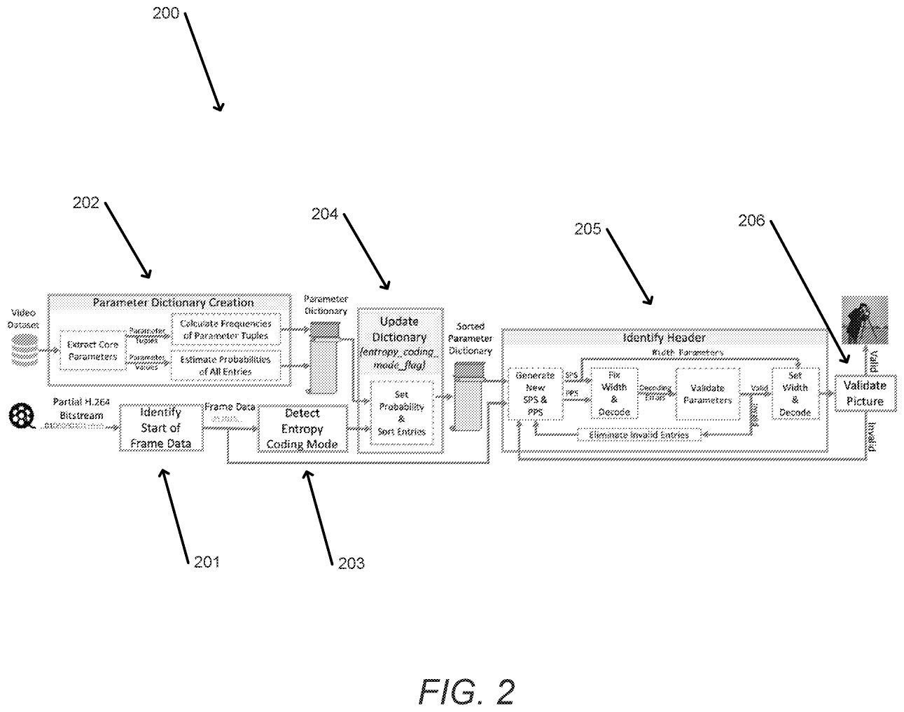

According to an embodiment of the present disclosure, a method for generating a Sequence Parameter Set and a Picture Parameter Set for decoding an H.264 coded video file fragment is provided. In an example, shown in FIG. 2, the process 200 of generating SPS and PPS sequence headers takes an input encoded I frame and a dictionary of coding parameters to determine the critical parameters needed for decoding.

In step one 201, the method uses the start of frame data to identify IDR headers in coded video files. In various embodiments, the start of coded frame data can be identified through the presence of specific byte patterns, which are included in the beginning of NAL units and the MP4 headers. At a high level, an H.264 coded bitstream is comprised of a stream of NAL units separated by a start code prefix. And, each NAL unit starts with a one-byte unit identifier comprised of a zero bit followed by a two-bit NAL reference identification field and a five-bit NAL unit type. Thus, to identify NAL units in MPEG-4 Visual and H.264 Annex-B formatted files, the embodiment searches for start codes specified in the bitstream. Once completed, the embodiment verifies that the start codes are followed by a header identifier. In many examples, the embodiment may search for the start codes of 0x00000001 or 0x000001. This process is used in set one to identify IDR headers in coded video files. Further, values in SPS and PPS do not typically change over a video. Therefore, once an I frame is reconstructed successfully, the same parameters can be used to decode the subsequent frames in an IDR.

In step two 202, which can be occur before, after, or concurrently with step one, the method creates a parameter dictionary. In many embodiments, the parameter dictionary is a collection of 63-tuples with each entry representing a realization of all parameters in SPS and PPS. Each parameter takes a value as defined in the last column of Table II. In many embodiments, the core parameters identified determines the complexity of generating the SPS and PPS headers.

TABLE II
Categorization of SPS and PPA Parameters and Defined Range of Values

| Header | Group | Variable Name | Possible Value |
|---|---|---|---|
| SPS | Core | pic_width_in_mbs_minus1 | 0-25.5 |
| | | frame_cropping_flag | 0-7 |
| | | frame_cropping_right | 0, 1 |
| | | log2_trots [symbol] -fraox_nom_minus4 | 0-12 |
| | | pic_order_cot_type | 0-2 |
| | | log2_max_pic_order_cnt_job_minus4 | 0-12 |
| | Fovarion [symbol] | chroma_format_idc | 0-3 |
| | | separate_colom [symbol] _plane_flag | 0, 1 |
| | | bit_depth_luma_minus8 | 0-6 |
| | | bit_depth_chroma_minus8 | 0-6 |
| | | frame_cropping_top-left | 0-7 |
| | | apprime [symbol] _y_zero_transform_bypass_flag | 0, 1 |
| | | delta_pic_order_always_zero_flag | 0, 1 |
| | | offset_for_(min)_ref_pic | (−2³³ + 1) − (−2³³ − 1) |
| | | or top_to_bottoms_field | |
| | | minus_ref_frame_in_pre_order_on_cycle | 0-25.5 |
| | | gaps_in_frame_minus_value_allowed_flag | 0, 1 |
| | | mb_adaptive_frame_field_flag | 0, 1 |
| | Interchangeable | seq_parameter_set_id | 0-31 |
| | | pantile [symbol] _idc | tx proites [symbol] |
| | | level_idc | 0-25.5 |
| | | constraint_set (0,1,2,3,4,5)_flag | 0-1 for each |
| | | seq_scaling_matrix_present_flag | 0-16 |
| | | pic_height_in_mbs [symbol] _minus1 | 0-25.5 |
| | | frame_rabs_only_flag | 0, 1 |
| | | frame_empping [symbol] _bottom | 0-7 |
| | | seq_scaling_list_present_flag[ i ] | 0, 1 |
| | | max_num_ref_frames | 0-16 |
| | | direct_8x8_inference_flag | 0, 1 |
| | | vmi [symbol] _parameters_present_flag | 0, 1 |
| PPS | Core | entropy_coding_mode_flag | 0, 1 |
| | | pic_unit_qp_minus26 | (−25)-26 |
| | | transform_8x8_mode_flag | 0, 1 |
| | | denblocking [symbol] _filter_contred [symbol] _consent_flag | 0, 1 |
| | Fovarion [symbol] | bottom_field_pic_order_in_frame_present_flag | 0, 1 |
| | | outo [symbol] _slice+groups_minus1 | 0-7 |
| | | slice_group_stop_type | 0-6 |
| | | [symbol] _length_minus1 | 0-256 |
| | | top_left[i]_bottom_right[i] | 0, 1 |
| | | slice_group_change_direction_flag | 0, 1 |
| | | slice_group_change_rate_minus1 | 0-2¹⁰ |
| | | pic_size_in_map_unite_minus1 | 0-2¹⁰ |
| | | slice_group_td[i] [symbol] | 0, 1 |
| | | chroma_qp_index_offset | (−12)-12 |
| | | construned [symbol] _intro_pond_flag | 0, 1 |
| | | redundant [symbol] _pic_on_present_flag | 0, 1 |
| | Interchangeable | pic_parameter_set_id | 0-25.5 |
| | | seq_parameter_set_id | 0-31 |
| | | num_ref_idx_1(0-3)_refaulr [symbol] _active_minus1 | 0-31 |
| | | weighted_pred_flag | 0, 1 |
| | | weighted_bipred_idc | 0-2 |
| | | pic_init_qs_minus26 | (−25)-26 |
| | | pic_scaling_matrix_present_flag | 0-16 |
| | | pic_scaling_list_present_flag[ i ] | 0-256 |
| | | second_chroma_qp_index_offset | (−12)-12 |

[symbol]

indicates data missing or illegible when filed

Overall, the dictionary contains around 3.5 billion entries considering possible values for 10 core parameters. Header entries are initially sorted in order of decreasing priority based on two criteria. The first criterion prioritizes the combination of core parameter values seen in the design set. Out of the 5,115 unique SPS and PPS headers that cover the design set, a set of 2,663 unique 10-tuples was observed.

Therefore, the first 2.6K header entries incorporate these values sorted based on their frequency in the design set. The second criterion determines the sorting of subsequent entries based on frequency of each parameter value. Since core parameters are independent of each other, the rank of each header is determined based on its estimated encounter probability computed as multiplication of marginal probabilities of each parameter.

In step three 203, the method detects an entropy coding-mode, which is the last step of encoding. The parameter that identifies the coding method may be CABAC or CAVLC. The parameter that identifies the coding method is important because the decoder may begin interpreting the data accordingly once the parameter is known.

To differentiate between CABAC and CAVLC, the method uses a simple classifier aimed at exploiting operational differences. Namely, Shannon entropy and 11 other features derived from byte frequencies were used, which included two Boolean features testing if the maximum frequency is due to byte-values 0x00 and 0xFF, the dispersion coefficient computed as the ratio of variance to the mean, the number of byte-values whose frequencies are 1.5 times more than the mean frequency of all byte values as well as six ratios. The latter six features are computed by dividing 0x00 byte frequency, 0xFF byte frequency, and the maximum frequency by the average and minimum frequencies observed in the entropy coded frame data.

These features are used to build a random forest classifier. The accuracy of the classifier is determined by performing five-fold cross-validation on a set of I frames encoded by one of the 5,115 SPS and PPS combinations. Of these combinations, 1,197 were coded using CAVLC and the remaining 3,918 were coded using CABAC. Since the two entropy coding methods, CAVLC and CABAC, may differentiated, the sorting of header entries in the dictionary must take this into account.

In step four 204, the method updates the parameter dictionary by re-sorting its entries. Namely, the encounter probability of the first 2.6K entries is multiplied by a value depending on the value of the entropy coding-mode parameter determined previously. For the remaining entries, the individual probability of encoding type measured across the design set is substituted with classifier's confidence in its prediction, and they are re-sorted within themselves according to their newly compute encounter probability. Then, the coded video sequence is decoded in order using headers in the updated dictionary until decoding succeeds.

The headers in the dictionary are initially sorted based on frequencies of 10-tuples and individual parameter values. The above approach essentially builds a binary classifier that predicts the likelihood of the two entropy coding methods, thereby reducing the search space by one parameter. Denoting the probability of CABAC coding by Pₑ and CAVLC coding by 1−Pₑ, the dictionary can be updated by re-sorting its entries. Accordingly, the encounter probability of the first 2.6K entries is multiplied by either Pₑ or 1−Pₑ depending on the value of the entropy coding-mode parameter. For the remaining entries the individual probability of encoding type measured across the design set is substituted with classifier's confidence in its prediction, and they are re-sorted within themselves according to their newly computed encounter probability. Then, the coded video sequence is decoded in order using headers in the updated dictionary until decoding succeeds.

In step five 205, the method identifies a plurality of headers. When decoding a given video sequence data, if the decoder is not correctly initialized, decoding eventually fails. In the case of the FFMPEG tool, this failure is implicit as the decoder persistently attempts to decode each subsequent picture until it reaches the end of coded data. To increase the efficiency of search, the method may use supplementary information, including built-in logs. These application logs record important events and provide critical information about the state of the decoder when it fails. Thus, this step exploits these error messages both to identify decoding failures and to investigate the mapping between error messages and correct parameter values for the header entries.

During decoding, when the assumed parameter values mismatch the actual values used for encoding, several error messages that relate to a missing block are logged. These errors may indicate that the decoder is unable to determine the reference block needed during the decoding of the current block. For example, error patterns may include a top block unavailable error, which indicates that at least one of the core parameters is incorrect, or a left block unavailable error, which indicates an incorrect picture width value. Overall, setting an incorrect value for the frame width results in misplacement of decoded picture blocks. Further, when the selected width value is smaller than the actual value, some picture blocks will inadvertently be carried over to the next row of blocks. The first misplaced block in that new row will likely raise this error as there will be no blocks to the left of it.

To exploit this behavior when exploring the parameter space, picture width may be set to the smallest possible value of one without cropping. Since frame resolution for most videos will be higher, this type of error can be utilized as a condition to test the case when all parameters but the width are correctly determined.

In step six 206, the method verifies whether a reconstructed picture exhibits characteristics of real images. In many embodiments, the correlation between the pictures generated using the identified header and the original header used for encoding were used. In various embodiments, the method verifies the picture based on the decoder output, which can be determined based on the absence of any decoding errors. Further, the decoding method attempts to show that when the decoder fails, in some cases a picture cannot be reconstructed, and many cases that a picture is erroneously constructed, it can be easily distinguished from real pictures.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method for generating a Sequence Parameter Set and a Picture Parameter Set for decoding an H.264 coded video file fragment, comprising:
identifying a start of frame data;
creating a parameter dictionary;
detecting an entropy coding-mode;
updating the parameter dictionary;
identifying a plurality of headers; and
verifying a generated picture.

2. The method of claim 1, wherein the start of frame data is identified by identifying an Instantaneous Decoder Refresh.

3. The method of claim 1, wherein the parameter dictionary comprises a plurality of tuples.

4. The method of claim 3, wherein the plurality of tuples represents a plurality of parameters in the Sequence Parameter Set, and wherein the plurality of tuples represents a plurality of parameters in the Picture Parameter Set.

5. The method of claim 4, wherein the plurality of parameters in the Sequence Parameter and the plurality of parameters in the Picture Parameter Set comprise core parameters.

6. The method of claim 1, wherein the entropy coding-mode is detected with a classifier.

7. The method of claim 6, wherein the classifier differentiates between a first entropy coding mode using a CABAC coding method and a second entropy coding mode using a CAVLC coding method.

8. The method of claim 1, wherein a correlation between the generated picture decoded with a generated header and an original picture decoded using an original header is used to verify the generated picture.

9. A method for generating a file header for decoding a file fragment, comprising:
constructing a dataset;
extracting a plurality of core parameters in the dataset; and
using the plurality of core parameters to create a parameter dictionary.

10. The method of claim 9, wherein the file fragment is a video file fragment encoded using an H.264 format.

11. The method of claim 9, wherein the file header comprises a Sequence Parameter Set.

12. The method of claim 9, wherein the file header comprises a Picture Parameter Set.

13. The method of claim 9, wherein the parameter dictionary comprises a plurality of tuples.

14. The method of claim 13, wherein the plurality of tuples represents a plurality of parameters in the Sequence Parameter Set, and wherein the plurality of tuples represents a plurality of parameters in the Picture Parameter Set.

15. The method of claim 14, wherein the plurality of parameters in the Sequence Parameter and the plurality of parameters in the Picture Parameter Set comprise core parameters.

16. A method for generating a plurality of parameters used for decoding a file fragment, comprising:
inputting a plurality of I frames and a parameter dictionary into a system, wherein the system executes the method comprising:
detecting an entropy coding-mode;
updating the parameter dictionary;
identifying a plurality of headers; and
verifying a generated picture.
